(19) United States
(12) Patent Application Publication
(10) Pub. No.: US 2011/0170290 A1
(43) Pub. Date: Jul. 14, 2011

(54) LIGHTING DEVICE AND METHOD OF LIGHTING

(75) Inventors: Rifat A.M. Hikmet, Eindhoven (NL); Ties Van Bommel, Horst (NL)

(73) Assignee: KONINKLIJKE PHILIPS ELECTRONICS N.V., EINDHOVEN (NL)

(21) Appl. No.: 13/119,202

(22) PCT Filed: Sep. 16, 2009
(86) PCT No.: PCT/IB2009/054045

§ 371 Date: Mar. 16, 2011

(30) Foreign Application Priority Data
Sep. 17, 2008 (EP) 08164516.0

(51) Int. Cl. F21V 8/00

(52) U.S. Cl. 362/235

(57) ABSTRACT

The invention relates to a lighting device (1) comprising at least one laser device (4) for generating an aligned laser beam (5), at least one LED device for generating light emission (3) and at least one optical element (6), which is in the optical path of the laser beam (5) and converts the laser beam (5) into structured laser light (8), wherein the arrangement of the laser device (4), the LED device and the optical element (6) enables a superposition of the light emission (3) and the laser light (8). The invention further relates to a corresponding method of lighting.

### FIELD OF THE INVENTION

The invention relates to a lighting device and a method of lighting.

### BACKGROUND OF THE INVENTION

Solid state lighting has enabled “color on demand” and it is introduced in many lighting applications ranging from decorative lighting, shop lighting to atmosphere creation. Light emitting diodes (LEDs) as well as organic light emitting diodes (OLEDs) are getting increasingly more powerful and they are employed in general lighting applications. OLED devices based lighting are suitable to be used in applications such as intelligent lighting tiles, intelligent product shelves, ambient intelligent lighting, signage (text, figures, . . . ), decorative lighting, where a person can directly look into the light source. For many applications it is desirable to generate an illumination with structured lighting effects. This illumination can be a static or a varying lighting with structured lighting effects.

### SUMMARY OF THE INVENTION

It is an object of the invention to provide a lighting device and a corresponding method of lighting with structured lighting effects.

This object is achieved by a low intensity lighting device comprising at least one laser device for generating an aligned laser beam, at least one LED device for generating light emission and at least one optical element, which is in the optical path of the laser beam and converts the laser beam into structured laser light, wherein the arrangement of the laser device, the LED device and the optical element enables a superposition of the light emission and the laser light.

With respect to the present invention, the term “low intensity lighting device” relates to such a lighting device which can be looked into with the human eye without hurting or injuring the eye, and more preferably to such a lighting device which is even adapted for looking into. Thus, examples for such low intensity lighting devices according to the invention are decorative lighting, shop lighting, lighting for atmosphere creation and signage lighting like fluorescent letters. In contrast to that, such lighting devices as projectors or pointers are not considered to be low intensity lighting device in terms of the invention, since these are neither suitable nor adapted for being looked into with the human eye. Though the overall amount of available light might even be less for the latter lighting devices, the light emitted from these devices should not directly enter the human eye due to the high light intensity and, thus, is typically perceived in an indirect way, e.g. by projecting the light onto a silver screen from which it is reflected back. The LED device is preferably a LED light tile comprising LED components (LEDs).

According to a preferred embodiment of the invention, the LED device is an OLED device.

An advantage of OLEDs is that they are thin, and light emission is from a large surface area. Thus, OLED devices are especially suitable for the invention since they can provide large illuminated areas in an easy and convenient way.

In order to enhance the lighting effect which can be obtained with LED devices, the structured laser light generates patterns which are superimposed on a background illumination generated by said LED device. A laser device is a light source having an extremely high energy density and is highly suitable for generating visible patterns and shapes using at least one simple optical element like a diffractive optical element which can also be switchable. A LED device, especially an OLED device, on the other hand on its own cannot be easily employed to generate sharp details but it has a high total output of light emission. The optical element is preferably a diffractive element or an electro optical element.

According to a preferred embodiment of the invention, a hybrid lighting device using at least one laser device and at least one OLED device is provided for illumination applications where high intensity patterns created by the laser light are superimposed on background illumination created by the light emission. Thus, lighting with structured lighting effects is achieved. In a preferred embodiment of the invention the LED device comprises a set of LED components (LEDs), preferably OLEDs, emitting light of different colors which by superposition of the colors can make white light emission. For example, the OLED device is a RGB OLED device comprising a first OLED emitting red (R) light with a wavelength of between 590 nm and 750 nm, a second OLED emitting green (G) light with a wavelength of between 495 nm and 590 nm and a third OLED emitting blue (B) light with a wavelength of between 450 nm and 495 nm. Alternatively, the OLED device can also be single color or a white OLED device.

Preferably, the optical element is an optical wave guide for the laser beam. The optical wave guide can preferably be a fiber wave guide. As already stated above, one of the advantages of OLEDs is that they are thin, and light emission is from a large surface area. The fact that lasers are point sources means that they can be easily coupled into a thin wave guide which can be placed on top of the OLED device without the use of additional coupling structures.

According to a preferred embodiment of the invention, the optical element comprises out-coupling structures and/or out-coupling elements, wherein each structure or element enables an out-coupling of a portion of the laser beam and wherein the portions build the laser light. Preferably, these out-coupling elements are provided with a predefined distance from each other. Each beam of this portion starts from the corresponding out-coupling structure and/or out-coupling element. The out-coupling structure is a structure of the optical element, wherein the optical element with said structure is a one piece optical element. The out-coupling element and the optical element are formed as a multiple piece optical element.

Generally, the path of the laser beam within the optical wave guide can have different kinds of orientations. Preferably the optical wave guide is oriented in a plane which is substantially parallel to a light emitting surface of the OLED device. The laser beam runs substantially in this plane. In particular the optical wave guide and the OLED device are arranged on top of one another and build a layered structure. Preferably, the optical wave guide is a planar optical wave guide.

The optical element comprises at least one reflector to elongate the optical path of the laser beam within the optical element. Said optical element is especially the planar optical wave guide comprising the out-coupling structures and/or out-coupling elements and the reflector.

According to a preferred embodiment of the invention the light emission trans-illuminates the optical element or the laser light trans-illuminates the LED device. The optical element is an at least partial transparent optical element or the LED device is an at least partial transparent LED device.

Generally, the path of the laser beam can have different orientations with respect to the light emission. Especially, the laser beam is oriented perpendicularly to a main component of the light emission.

In another preferred embodiment of the invention the wave guide comprises at least one LED component, which is preferably placed at an edge of the wave guide. The LED component is emitting uniform low intensity light, which is coupled out from the wave guide. The wave guide with the LED component is preferably the LED light tile.

According to another preferred embodiment of the invention, the LED components form an LED array. Preferably, a diffuser is placed on top of the wave guide to obtain low intensity light distribution.

In another preferred embodiment of the invention, the LED light tile is covered by a luminescence layer, in particular a phosphor layer. The LED light tile is in a so called remote phosphor configuration. The LED components are preferably LEDs emitting blue light. The phosphor layer is placed above the LED components to convert the blue light partially or totally to another color light.

According to another preferred embodiment of the invention, an OLED device is combined with one of the aforementioned LED light tiles. For example a transparent OLED device is placed on top of the LED light tile with a diffuser plate placed above them or a transparent OLED device where LED components are coupled into the substrate of the OLED device from the sides. In the above mentioned embodiments of the invention the LED components can be driven in a way for producing homogeneous colors but they may also produce patterns which can also show dynamic effects.

Preferably, the light emission shows a component, which is oppositely oriented to a main component of laser light. In this case the laser light is illuminating the LED device.

The lighting device can further comprise an optical element wheel which is suitable to bring one of the optical elements at a time in the optical path of the laser device.

The invention further relates to a method of lighting, in particular using one of the aforementioned lighting devices, with at least one LED device which generates light emission, at least one laser device which generates an aligned laser beam and at least one optical element which is in the optical path of the laser beam and converts the laser beam into structured laser light, wherein the laser light is superposed on the light emission. In order to enhance the lighting effect which can be obtained with the light emission of the LED devices, the structured laser light generates patterns which are superimposed on a background illumination generated by said LED device.

The LED device is preferably an OLED device. The lighting can be a static or a varying illumination of an object with structured lighting effects. Preferably, different optical elements are mechanically moved into the optical path of the laser beam. These different optical elements generate different structured patterns.

Dynamic lighting effects are preferably generated by driving or switching at least one drivable optical element, preferably based on liquid crystal for producing active beam shapes. According to a preferred embodiment of the invention an object is illuminated and the object shape and/or the object size is/are detected by a sensor to generate an object dependent structured lighting. This type of object dependent structured lighting is preferably controlled by a lighting control system driving the at least one optical element and/or moving the different optical elements. The lighting device comprises at least two LED devices which are electrically driven to produce different dynamic light colors and patterns.

### BRIEF DESCRIPTION OF THE DRAWINGS

These and other aspects of the invention will be apparent from and elucidated with reference to the embodiments described hereinafter.

In the drawings:

FIG. 1A shows a vertical sectional view of a lighting device according to a first embodiment of the invention;

FIG. 1B shows a top view of the lighting device of FIG. 1A;

FIG. 2A shows a top view of a lighting device according to a second embodiment of the invention;

FIG. 2B shows a wave guide where LEDs are placed at the edge of a wave guide;

FIG. 2C shows an array of LED components with a diffuser is placed on top;

FIG. 2D shows LED light tile, which is in a so called remote phosphor configuration with a phosphor layer, which is placed above the Light tile with blue LEDs;

FIG. 2E shows a transparent OLED, which is placed on top of LEDs with a diffuser;

FIG. 2F shows a transparent OLED device on top of a wave guide where LED light is coupled in from the sides;

FIG. 3 shows a vertical sectional view of a lighting device according to a third embodiment of the invention;

FIG. 4 shows a vertical sectional view of a lighting device according to a fourth embodiment of the invention;

FIG. 5 shows a top view of a lighting device according to a fifth embodiment of the invention;

FIG. 6 shows a side view of a lighting device according to a sixth embodiment of the invention;

FIG. 7 shows a vertical sectional view of a lighting device according to a seventh embodiment of the invention;

FIG. 8 shows a vertical sectional view of a lighting device according to a eighth embodiment of the invention;

FIG. 9 shows a vertical sectional view of a lighting device according to a ninth embodiment of the invention;

FIG. 10 shows a vertical sectional view of a lighting device with a group of movable optical elements according to a tenth embodiment of the invention and a top view of said elements;

FIG. 11 shows a vertical sectional view of a lighting device according to an eleventh embodiment of the invention;

FIG. 12 shows a vertical sectional view of a lighting device according to a twelfth embodiment of the invention;

FIG. 13 shows a vertical sectional view of a lighting device according to a thirteenth embodiment of the invention; and

FIG. 14 shows a vertical sectional view of a lighting device according to a fourteenth embodiment of the invention.

### DETAILED DESCRIPTION OF EMBODIMENTS

From FIG. 1 the general arrangement and operation principle of a lighting device 1 according to a preferred embodiment of the invention can be seen. The lighting device 1 comprises an OLED device 2 for generating light emission 3, a laser device 4 for generating an aligned laser beam 5 and an optical element 6, which is in the optical path 7 of the laser beam 5 and converts the laser beam 5 into structured and expanded laser light 8. The optical element 6 is an optical wave guide 9 for the laser beam 5 which is oriented in a plane 10. This plane 10 is parallel to a light emitting surface 11 of the OLED device 2. Said optical wave guide 9 is formed as a planar optical wave guide 12. The optical wave guide 9 comprises spaced arranged out-coupling structures 13 arranged at its undersurface. Each structure 13 enables an out-coupling of a portion 14 of the laser beam 5. The sum of the portions 14 build the laser light 8. The light emission 3 of the OLED device 2 arranged underneath the wave guide 9 trans-illuminates said optical wave guide 9 and the laser light 8 above the wave guide 9 is superposed on the light emission 3 of the OLED device 2.

The out-coupling structure 13 is a structure for leaking some of the laser light 8 out of the wave guide 9 at a particular point. The out-coupling structure 13 can also be a wavelength conversion material such as phosphor where light is converted to other wavelengths. FIG. 1B shows a top view of the lighting device 1 of FIG. 1A. The planar optical wave guide 12 comprises two reflectors 15 to elongate the optical path 7 of the laser beam 5 within the planar optical wave guide 12.

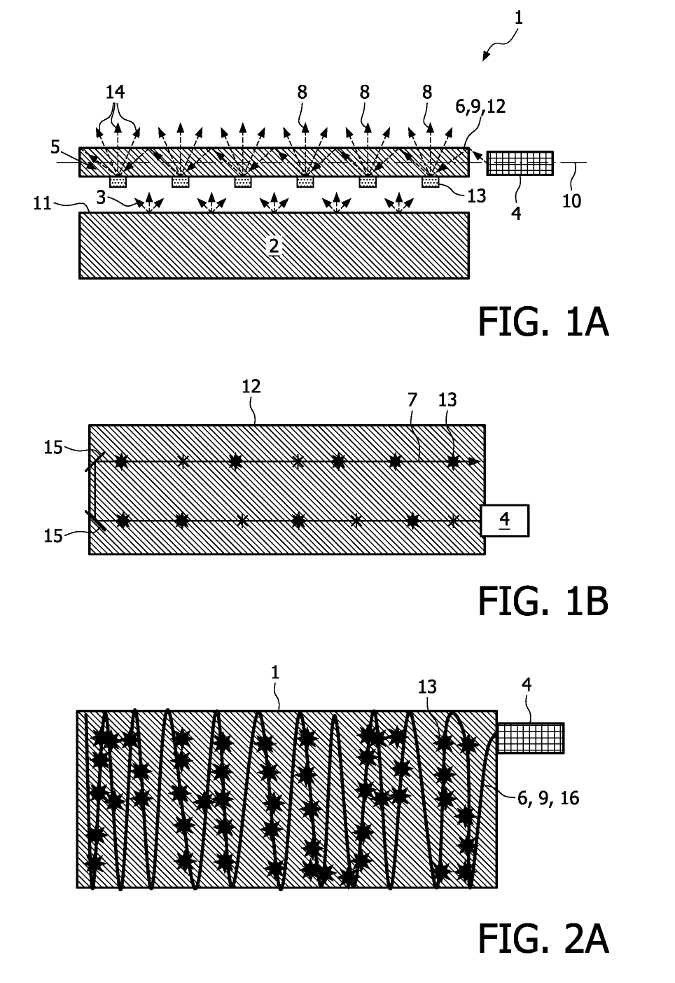

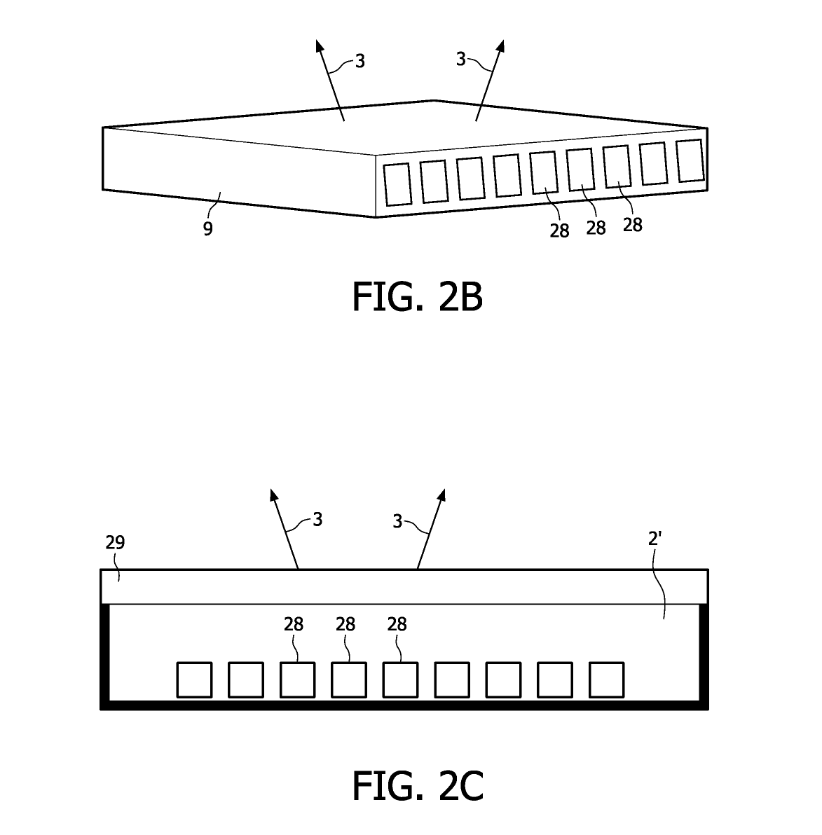

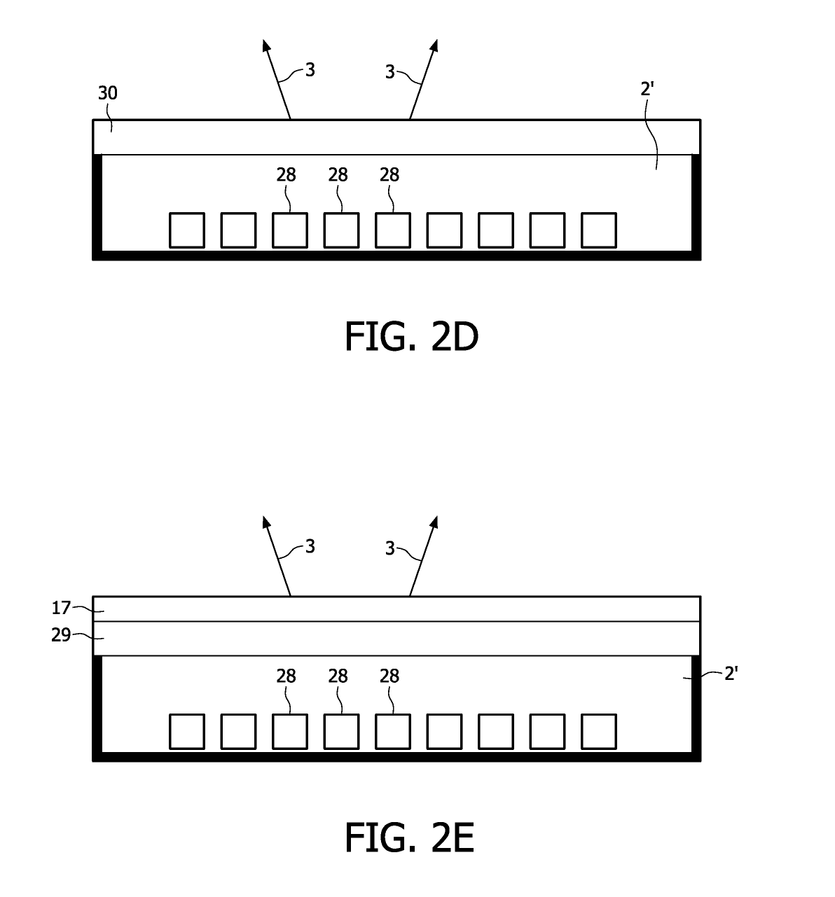

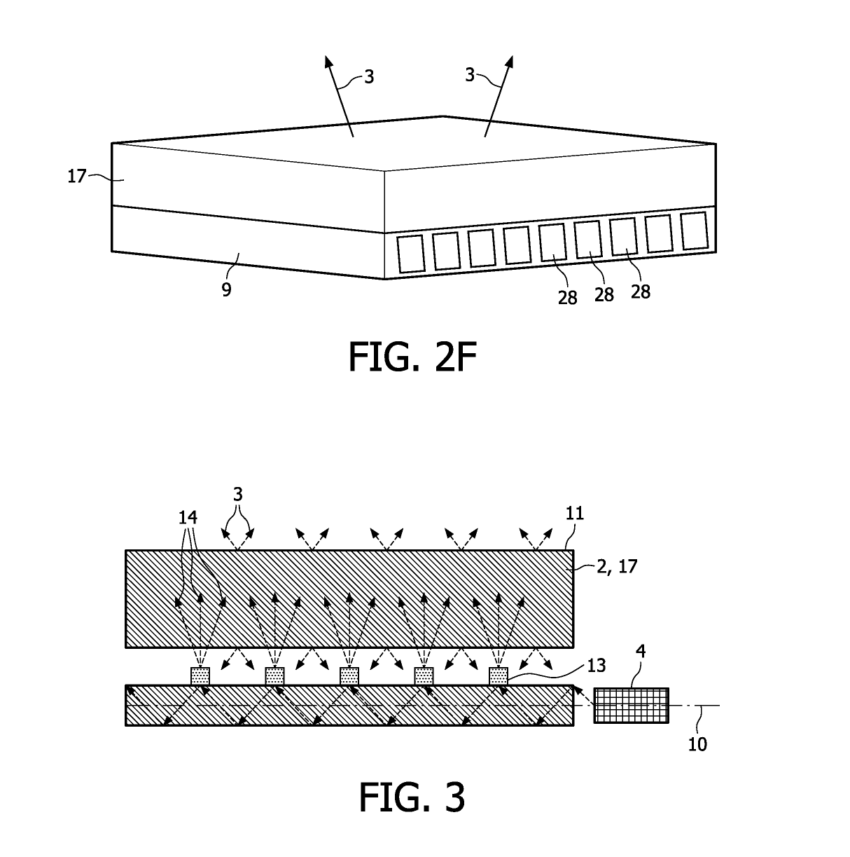

Instead of using a planar optical wave guide 12 it is also possible to use other types of optical wave guides 9 such as an optical fiber wave guide 16 as shown in FIG. 2A. It is also possible to combine the wave guide structures with a transparent OLED device 17 as shown in FIG. 3.

In FIGS. 1A, 1B and 2A instead using OLED device 2 it is also possible to use low intensity LED devices 2′ (LED light tiles) shown in FIG. 2 B to FIG. 2F.

The wave guide 9 shown in FIG. 2B comprises at least one LED component 28, which is preferably placed at an edge of the wave guide. The LED component 28 is emitting uniform low intensity light, which is coupled out from the wave guide 9.

In FIG. 2C the LED components 28 form an LED array. A diffuser 29 is placed on top of the wave guide 9 to obtain low intensity light distribution.

As shown in FIG. 2D, a LED light tile (LED device 2′) is covered by a luminescence layer 30, in particular a phosphor layer. The LED light tile is in a so called remote phosphor configuration. The LED components 28 are preferably LEDs emitting blue light. The phosphor layer is placed above the LED components 28 to convert the blue light partially or totally to another color light.

In FIG. 2E a transparent OLED device 17 is combined with one of the aforementioned LED light tiles. For example a transparent OLED device 17 is placed on top of the LED light tile with a diffuser 29 placed above them or a transparent OLED device 17 where LED components 28 are coupled into the substrate of the OLED device 17 from the sides.

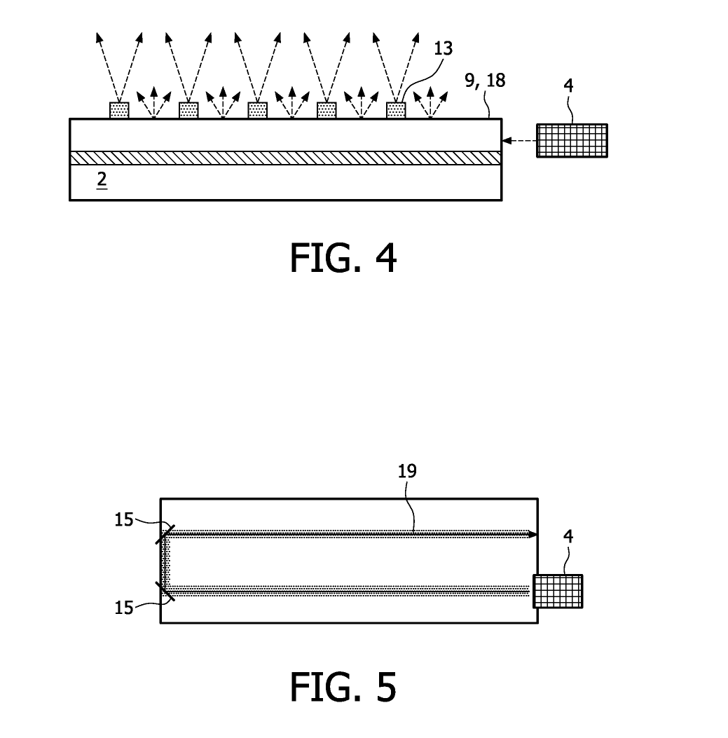

Instead of using a separate optical wave guide 9 it is also possible to use a substrate 18 of the OLED device 2 as a wave guide 9 as shown in FIG. 4. In this embodiment a configuration of the lighting device 1 is used, where out-coupling structures 13 are placed on top of the optical wave guide 9 (substrate 18). However other configurations are also possible. The optical wave guide 9 and the OLED device 2 can be arranged on top of one another and build a layered structure.

In FIG. 5 another embodiment is shown, where the active layer 19 of the OLED device 2 is excited by the laser device 4 for extra light emission 3 from this layer 19. Such an emission 3 can also become superimposed on top of the laser light 8.

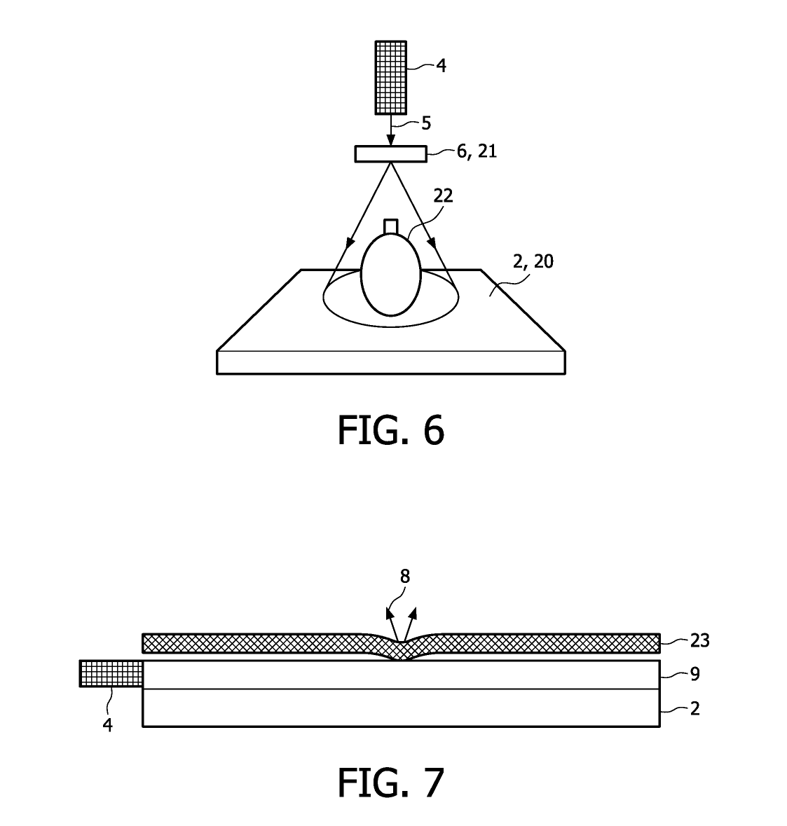

The OLED device 2 can also be used as a screen 20 where a laser pattern is projected onto it. The projection can be from above or from behind. FIG. 6 shows an example where laser light 8 is projected onto an OLED device 2 (OLED tile) from above. The laser light 8 is produced by the laser beam 5 of the laser device 4 and an optical element 6 which is a diffractive element 21. The lighting device illuminated an object 22 with structured lighting effects. The laser light 8 shows a component, which is oppositely oriented to a main component of the LED light emission.

As mentioned before, the projected image may be representative of the emission color of the laser device 4. However the OLED device 2 may also be provided with a luminescent layer for converting the laser beam 5 and/or the laser light 8 to other colors. In the same way the laser beam 5 and/or the laser light 8 may just excite the active layer 19 of the OLED device 2.

In addition to the examples above the OLED device 2 may also be provided with a touch screen 23 where the point of touching laser light 8 can be coupled out as shown in FIG. 7.

In FIGS. 6 and 7 instead using OLED devices 2 it is also possible to use low intensity LED light tiles 2′ shown in FIGS. 2C to 2F.

In addition to the example above, the OLED device(s) or (LED) light guide(s) may be non-planar. For instance the the OLED device(s) or (LED) light guide(s) may be curved.

In previous embodiments of the invention low intensity light sources which one can look into are described. It is also possible to use light sources with high intensity for surface illumination where light is superimposed on the light originating from OLED and LED.

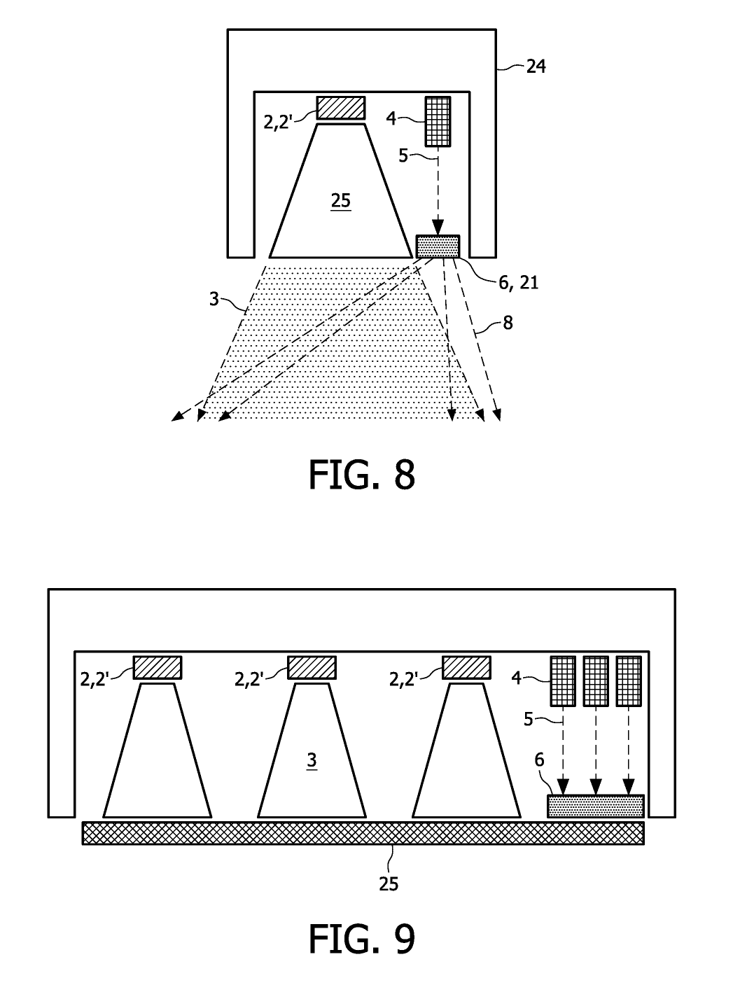

In FIG. 8 the LED device 2′ is an LED device 2′ comprising a set of three LED components (RGB LEDs) emitting light of different colors which by superposition of the colors can make white light emission. These three LED components are placed in a mixing chamber 24 with a collimator 25 for uniform illumination from the LED device 2′. Single or multiple laser devices 4 can then be used in combination with a diffractive element 21 for producing desired patterns or other structures. In the same way one can produce multiple RGB LED device units for illuminating multiple areas in combination with laser devices 4 as schematically shown in FIG. 9.

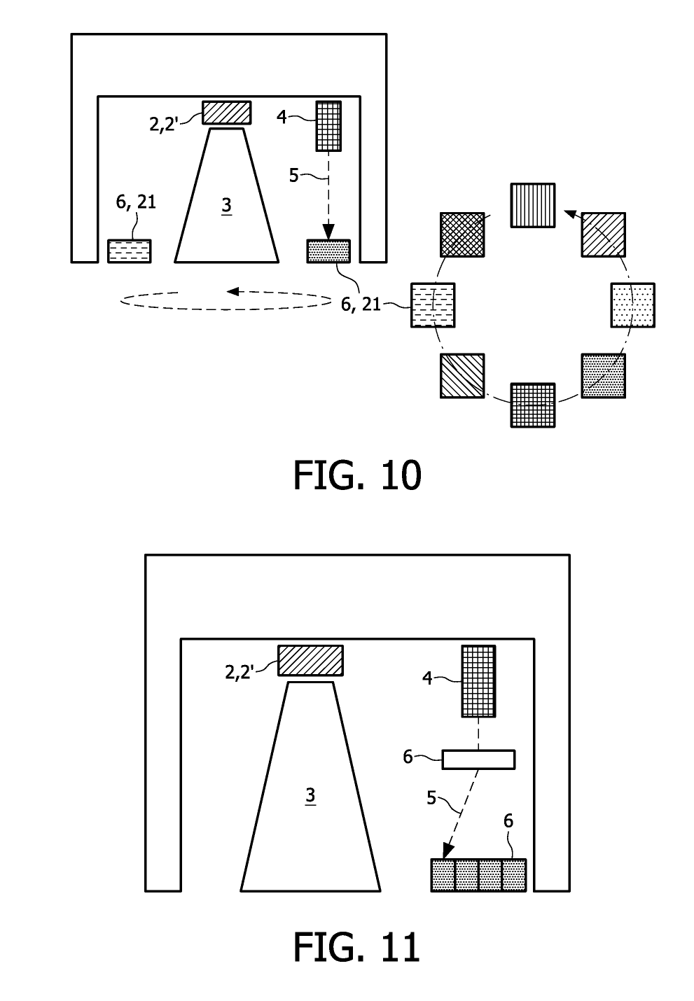

The lighting device 1 shown in FIG. 10 comprises an optical element wheel (not shown) which is suitable to bring one of the optical elements 6 at a time in the optical path 7 of the laser device 4. The diffractive optical elements 21 are mechanically moved bringing each time another element 21 into position in front of the laser device 4.

In the same way one can move the laser beam 5 using optical elements 26 bringing it each time onto another optical element 6 to produce different patterns as shown in FIG. 11.

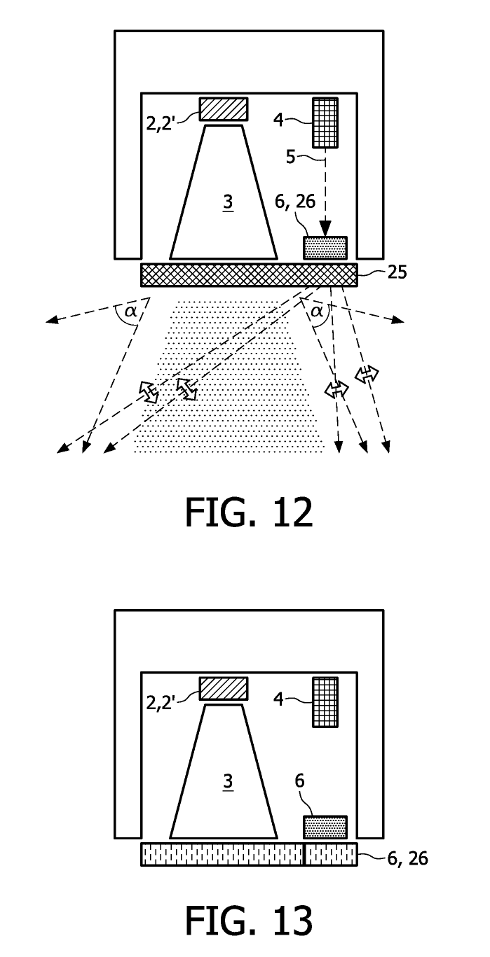

For producing dynamic effects one can use switchable optical elements 6 for example based on liquid crystals for producing active beam shapes. This can be done either by separate optical elements 6 as shown in FIG. 12 or integrated optical elements 6 shown in FIG. 13.

The electro-optical elements 6 which can be used are spatial light modulators, liquid crystal GRIN lenses (GRIN: Gradient Index), liquid, crystal cell with diffractive lens arrays, liquid crystal cell with photonic crystals, liquid crystal cell with holograms, electro-wetting lens/fluid focus, movable optical elements, for example mirror, gratings or other optical elements.

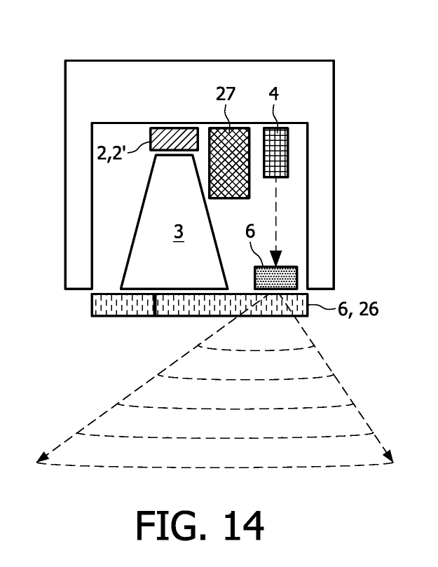

The lighting device 1 (hybrid lamp) can further be provided with various sensors 27. For example a movement sensor 27 can be used for illumination of patterns superimposed on a background illumination dependent on the presence or actions of people as illustrated in FIG. 14. The sensor 27 can be a product shape/size sensor to produce product dependent illumination of patterns superimposed on a background illumination. Such a sensor 27 can also be a RFID sensor (RFID: Radio Frequency Identification).

Such lighting device 1 can be used in applications such as retail lighting, ambient intelligent lighting, signage (text, figures . . . ), decorative lighting. In the case of OLED devices 2 or LED devices 2′ alone an object can be illuminated without any further information. Using a laser device 4 one can introduce contours and patterns.

In the drawings above laser device 4 indicates a single or multiple laser sources. It may also have RGB colors. It is also possible to use active elements in combination with the lasers to produce dynamic effects. These dynamic effects of lasers can be combined with dynamic colors and patterns produced by LED device 2′ and/or OLED devices 2.

In all previous embodiments the lighting devices 1 (OLED-laser devices and LED-laser devices) can be addressed for producing dynamic light colors and light patterns. For instance, pixilated OLEDs can be addressed by active matrix addressing. LEDs can be addressed by pulse width modulation.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A low intensity lighting device, comprising:
at least one laser device for generating an aligned laser beam,
at least one LED device for generating light emission and
at least one optical element, which is in the optical path of the laser beam and which is adapted for converting the laser beam into structured laser light,
wherein the arrangement of the laser device, the LED device and the optical element enables a superposition of the light emission and the laser light.

2. The lighting device according to claim 1, wherein the optical element is an optical wave guide for the laser beam.

3. The lighting device according to claim 1, wherein the optical element comprises out-coupling structures and/or out-coupling elements, which enables out-coupling of a portion of the laser beam, respectively, wherein the portions form the laser light.

4. The lighting device according to claim 2, wherein the optical wave guide is oriented in a plane which is parallel to a light emitting surface of the LED device.

5. The lighting device according to claim 2, wherein the optical wave guide is a planar optical wave guide.

6. The lighting device according to claim 1, wherein the optical element comprises at least one reflector to elongate the optical path of the laser beam within the optical element.

7. The lighting device according to claim 1, wherein the light emission trans-illuminates the optical element or the laser light trans-illuminates the LED device.

8. The lighting device according to claim 1, wherein the laser beam is oriented perpendicularly to a main component of the light emission.

9. The lighting device according to claim 1, wherein the laser light shows a component which is oppositely oriented to a main component of the light emission.

10. The lighting device according to claim 1, wherein the lighting device further comprises an optical element wheel for bringing one of the optical elements at a time into the optical path of the laser device.

11. The lighting device according to claim 1, wherein the LED device is an OLED device.

12-15. (canceled)
